(19) United States
(12) Patent Application Publication
(10) Pub. No.: US 2004/0192822 A1
(43) Pub. Date: Sep. 30, 2004

(54) Thin injection molded articles

(76) Inventors: Junji Shirai, Kariya-city (JP); Isamu Inai, Chita-gun (JP); Hiroyuki Wakabayashi, Kariya-city (JP); Kazutoyo Osuka, Handa-city (JP); Makoto Kato, Aichi (JP); Arimitsu Usuki, Aichi (JP)

Correspondence Address: HARNESS, DICKEY & PIERCE, P.L.C., P.O. BOX 828, BLOOMFIELD HILLS, MI, 48303, US

(21) Appl. No.: 10/774,293

(22) Filed: Feb. 6, 2004

Related U.S. Application Data
(63) Continuation-in-part of application No. 09/703,927, filed on Nov. 2, 2000.

(30) Foreign Application Priority Data
Nov. 11, 1999 (JP) 11-321414

(51) Int. Cl. C08K 3/34

(52) U.S. Cl. 524/445

(57) ABSTRACT

A thin injection molded article is composed of a composite resin material of organic clay 2 dispersed in a polymer 1. The polymer comprises a blend of polyphenylene oxide and a butadiene-styrene copolymer. The relationship between the maximum flow length L of the composite resin material in the thin injection molded article and the average thickness t of the thin injection molded articles satisfies the inequality: L/t≧70.

### CROSS-REFERENCE TO RELATED APPLICATIONS

This application is a continuation-in-part of U.S. patent application Ser. No. 09/703,927 filed on Nov. 2, 2000. This application further claims the benefit of Japan 11-321414, filed Nov. 11, 1999. The disclosures of the above applications are incorporated herein by reference.

### FIELD

The present invention relates to thin injection molded articles, and particularly to thin injection molded articles that are lightweight and have a required rigidity.

### BACKGROUND

Attempts to create thinner injection molded parts usually result in a lack of rigidity. The resins used in such thin parts may therefore satisfy the reciprocal properties of, firstly, high rigidity of thin sections, and secondly, high flow properties of the resin during injection.

Rigidity has conventionally been improved by adding glass fiber to resins. When glass fiber is added to a resin, however, the flow properties during resin melting are reduced, thus impairing the molding properties of the thin part. When injection molding is forcibly carried out under severe molding conditions such as high speed and high pressure in order to improve the molding property, there is a risk of deterioration of the resin by shear heat between the resin and the mold. Thin resin parts must also be lightweight and have good electrical insulating properties.

Although it has also been proposed to add organic clay to polymers instead of glass fiber, such as disclosed in Japanese Unexamined Patent Publication HEI No. 11-92677, it remains desirable to obtain a desired rigidity with a thin component.

### SUMMARY

A method and composition is to provide lightweight thin injection molded articles with high rigidity and excellent electrical insulating properties.

The present invention provides a thin injection molded article composed of a composite resin material having organic clay dispersed in a polymer, wherein the polymer comprises polyphenylene oxide and a butadiene-styrene copolymer, and the relationship between the maximum flow length L of the composite resin material in the thin injection molded article and the average thickness t of the thin injection molded article satisfies the inequality: L/t≧70.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration showing the relationship between polyphenylene oxide (PPO) and clay rendered organic with one type of organic agent;

FIG. 2 is an illustration showing the relationship between PPO and clay rendered organic with two or more types of organic agent;

FIG. 3 is an illustration showing organic clay and a polymer according to the invention;

FIGS. 4a, 4b, 4c and 4d are perspective views of cavities for injection molding, for illustration of different gate shapes and maximum flow lengths according to the present invention;

FIGS. 5a and 5b are perspective views of thin injection molded articles;

FIGS. 6a, 6b, 6c, 6d, 6e and 6f are illustrations showing the flow condition of a resin in a cavity for examples and comparative examples;

FIG. 7 is a line graph showing the relationship between tensile modulus and L/t for thin injection molded articles of the examples and the comparative examples;

FIG. 8 is a line graph showing the relationship between filler content and relative tensile modulus for thin injection molded articles of the examples and the comparative examples;

FIG. 9 is a line graph showing the relationship between maximum flow length L and L/t for thin injection molded articles with the rigidity required for manufactured products, according to the examples and the comparative examples; and

FIG. 10 is an illustration detailing the procedure used to determine the dielectric characteristics of the test sample.

### DETAILED DESCRIPTION OF VARIOUS EMBODIMENTS

The following description of various embodiments is merely exemplary in nature and is in no way intended to limit the invention, its application, or uses.

Polymers made of polyphenylene oxide (hereunder, “PPO”) and butadiene-styrene copolymer (hereunder, “BS copolymer”) may have high compatibility with organic clay. Composite resins composed of such polymers and organic clay may assist in providing high rigidity for injection molded articles, and thus allow realization of thinner injection molded articles. The injection molded articles formed of these materials may also have lighter specific densities and excellent electrical insulating properties.

Such thin injection molded articles have a relationship between maximum flow length L of the composite resin material and average thickness t of the thin injection molded article that satisfies the inequality L/t≧70. They consequently have high flow properties and can give thinner injection molded articles. However, when L/t<70 it may no longer be possible to achieve thinner injection molded articles.

The present invention, therefore, can provide lightweight thin injection molded articles with high rigidity and excellent electrical insulating properties.

Polymers composed of PPO and BS copolymer include modified polyphenylene oxide (hereunder, “modified PPO”). Modified PPO is a resin of PPO modified with HIPS (high impact polystyrene). Here, the term “modified” means that the PPO and HIPS are kneaded in a molten state. HIPS is a butadiene-styrene block copolymer.

Polymers comprising PPO and BS copolymer have better properties such as clay dispersability, resin flow properties and toughness compared to polymers composed only of PPO and containing no BS copolymer. Modified PPO exhibits an even higher dielectric breakdown.

Organic clay is clay (clay mineral) that has been rendered organic with an organic agent.

As clays there may be mentioned montmorillonite, saponite, hectorite, beidellite, stevensite, nontronite, vermiculite, halloysite, mica, fluorinated mica, kaolinite, pyroferrite, and the like. Natural or synthetic clays may be used. Sheet silicates such as montmorillonite are preferred because they allow greater improvement in mechanical strength.

An example of an organic agent is an organic onium ion. As organic onium ions there may be used primary to quaternary ammonium ions, such as hexylammonium ion, octylammonium ion, 2-ethylhexylammoniumion, decylammonium ion, dodecylammonium ion, laurylammonium ion, hexadecylammonium ion, octadecylammonium ion, dioctyldimethylammonium ion, trioctylammonium ion, dioctadecyldimethylammonium ion, trioctadecylammonium ion, and the like.

Other organic onium ions include phosphonium ions. As phosphonium ions there may be used tetraethylphosphonium ion, triethylbenzylphosphonium ion, tetra-n-butylphosphonium ion, tri-n-butylhexadecylphosphonium ion, tri-n-butylbenzylphosphonium ion, and the like.

The organic clay content in the thin injection molded article of the invention is preferably 1-5 parts by weight to 100 parts by weight of the polymer. With less than 1 part by weight there is a risk of insufficient rigidity of the molded article. With greater than 15 parts by weight, the molded article may become brittle and tend to break. More preferably, the organic clay content is 3-7 parts by weight to 100 parts by weight of the polymer. This will further improve the rigidity and impact fracture resistance of the molded article.

The organic clay in the molded article of the invention is preferably one wherein the clay has been rendered organic with two or more organic agents. Using such an organic clay can result in a larger L/t ratio, and molding of a thinner injection molded article.

The two or more organic agents may be selected from among the aforementioned primary to quaternary ammonium ions or phosphonium ions. A preferred example is a combination of dodecylammonium ion and octadecylammonium ion, with a dodecylammonium ion/octadecylammonium ion proportion of 0.01-100. The two or more different organic agents and their mixing proportions may be freely selected.

Using an organic clay that has been rendered organic with two or more organic agents can give an even larger L/t ratio and allow molding of thinner molded articles for the reason described below.

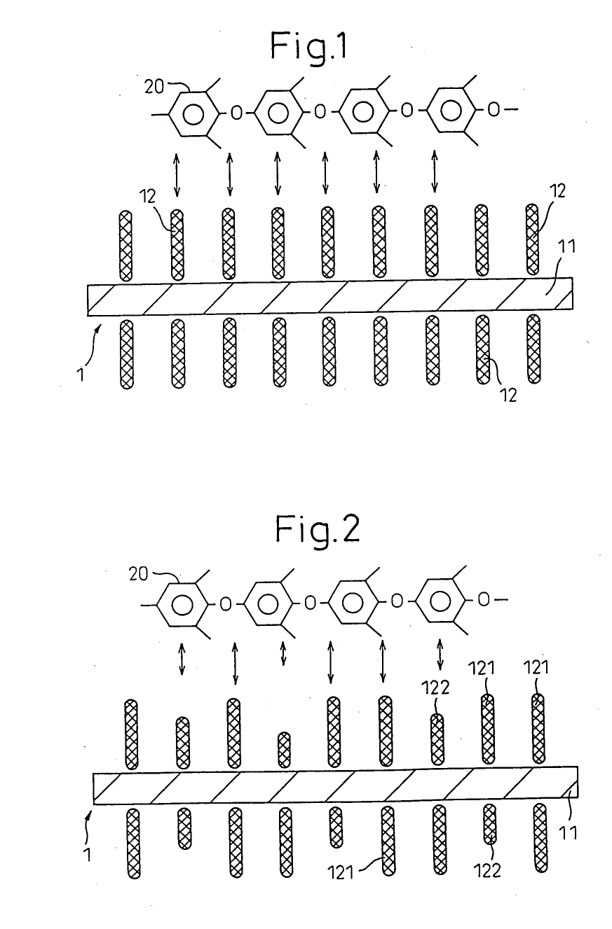

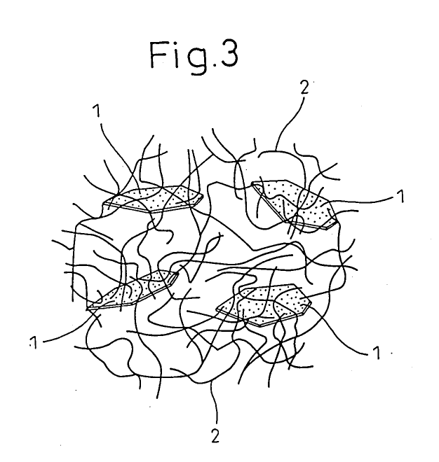

As shown in FIG. 1, the clay 11 in the organic clay 1 is surrounded by the organic agent 12. The surface of the organic clay 1 that has been obtained by treatment of clay 11 with one type of organic agent 12 is covered with equal length carbon chains of the organic agent 12, and thus becomes even. On the other hand, as shown in FIG. 2, an organic clay 1 obtained by treatment of clay 11 with two or more different organic agents 12 has an uneven surface due to the different lengths and three-dimensional structures of the organic agents 121, 122. The PPO (20) in the polymer is bonded to the clay 11 by hydrogen bonds or Van der Waals forces, while also interacting and bonding with the organic agent 12 on the surface of the clay 11 or the carbon chains bonded to the organic agent 12. Because blends comprising PPO and BS copolymer are rigid, the interaction occurs more readily with organic clay having a surface covered with even carbon chains. Clay that has been rendered organic with two or more organic agents has an uneven surface, and therefore variation is produced in the interactive force with the PPO, in some cases resulting in sections which undergo no interaction. Thus, when clay has been rendered organic with two or more organic agents such that variation exists in the interactive force, peeling of the organic clay and the PPO tends to occur due to a shear force produced during injection molding. The flow properties of the composite resin comprising the polymer and organic clay are therefore further improved, allowing molding of a thinner molded article than by using one type of onium ion.

The same effect can also be achieved by using two or more clays rendered organic with organic agents, for molding of thin molded articles. This is for the same reason explained above, as the combination of two or more clays produces variation in the interactive force with the PPO, thus facilitating peeling of the organic clay and PPO.

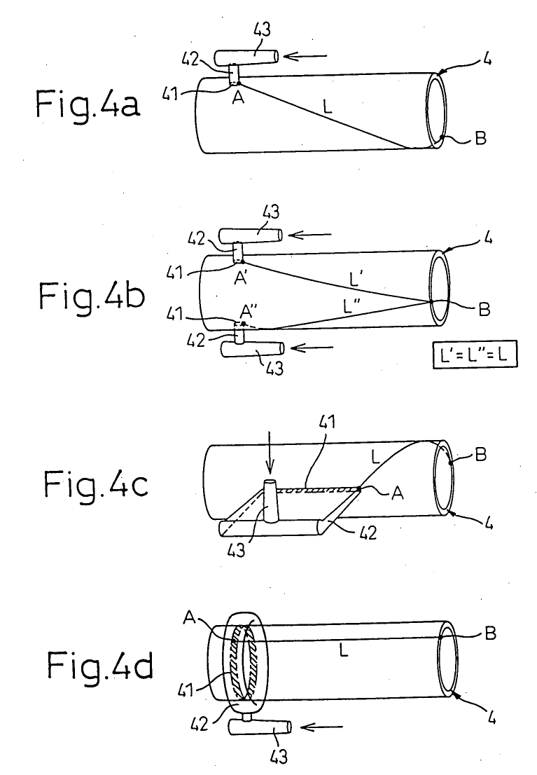

The organic clay 1 is dispersed in the polymer 2 as shown in FIG. 3. The organic clay preferably loses its layer structure in the polymer 2, becoming dispersed as a monolayer. This increases the proportion of the polymer restricted by the organic clay, and enhances the reinforcing effect of the organic clay.

The dielectric breakdown is higher when the clay is dispersed as a monolayer. This is because clay is insulating, and the breakdown current cannot pass through and must detour. That is, it appears as if the thickness has been increased.

The organic clay is preferably dispersed to a size no greater than 1 μmin the polymer. This will improve the mechanical properties of the molded article. The polymer also preferably intervenes between the clay layers. This will increase the interface between the clay surface and the polymer, and enhance the polymer reinforcing effect of the clay.

The distance between the organic clay layers, due to the PPO intervening between the dispersed and separated clay layers, is preferably 50 angstroms or greater. This will enhance the reinforcing effect of the clay on the elastic modulus, etc. The distance between the dispersed and separated organic clay layers is more preferably 100 angstroms or greater. This will exhibit the maximum reinforcing effect.

The layers of the organic clay are preferably separated as described above, but there is no need for all of the clay layers to be separated. There will be variations in the organic treatment of the clay, and portions of the clay may be aggregated. This is sufficient if only a portion adequately exhibits the reinforcing effect.

According to the invention, the relationship between the maximum flow length L of the composite resin material in the thin injection molded article and the average thickness t of the thin injection molded article is such that L/t≧70. The “maximum flow length of the composite resin material in the thin injection molded article” is the distance between the origin A of the injection molding gate and the furthest point B from the origin A in the thin injection molded article molded in the cavity. The origin A is the site of the gate that is at closest proximity to point B.

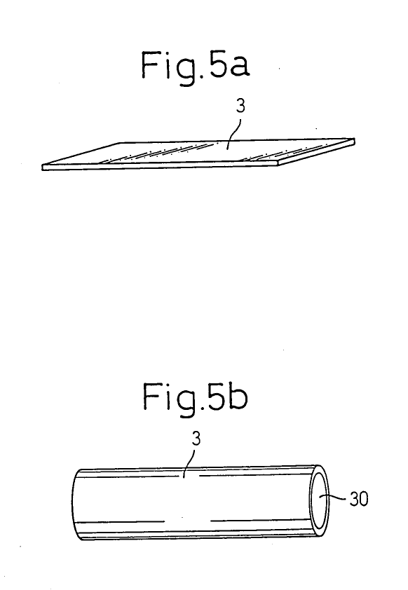

For example, as shown in FIG. 4a, in the cavity 4 of a cylinder for molding of a cylindrical thin injection molded article, the maximum flow length L is the distance between the origin A of the gate 41 and the furthest point B at the edge of the cylinder. When multiple gates 41 are provided in the cavity 4, as shown in FIG. 4b, the maximum flow length L according to the invention is the longest flow length of the maximum flow lengths L′, L″ from origins A′, A″ of each gate 41. When the maximum flow lengths L′ and L″ from the origins A′ and A″ of two gates 41 are equal, as shown in FIG. 4b, either one constitutes the maximum flow length L for the composite resin material of the thin injection molded article.

The “gate” is a narrow opening at the section of the cavity where the molten composite resin material enters from a runner. The gate 41 may be a pin gate with a point opening (FIGS. 4a, 4B), a film gate with a linear opening (FIG. 4c) or a ring gate with a disk-shaped opening (FIG. 4d). For all of these gates, the maximum flow length L is determined by defining the origin A as the location of the gate nearest the furthest point B. In the gate 41, a sprue 43 through which the molten composite resin material is supplied is connected via a runner 42 which conducts the composite resin material from the sprue 43 to the gate 41.

According to the invention, the “average thickness t of the thin injection molded article” is the average value for the thickness of the thin injection molded article. The average thickness t of the thin injection molded article is preferably 0.3-2.0 mm. At less than 0.3 mm the rigidity of the injection molded article may be unsustainable, and at greater than 2.0 mm the weight of the injection molded article may be insufficient.

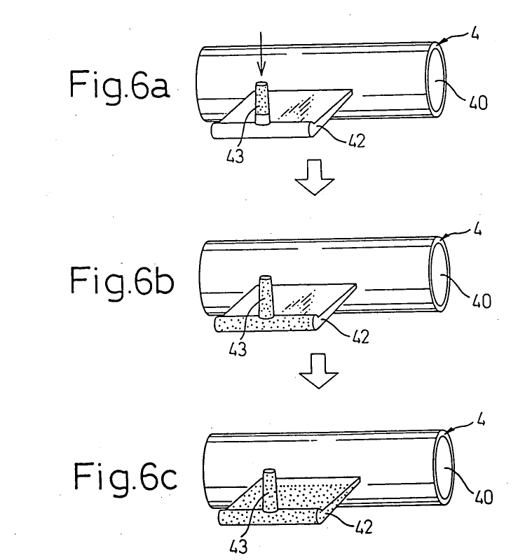

The shape of the thin injection molded article is not particularly limited so long as it is thin and, for example, it may be planar (FIG. 5a), cylindrical (FIG. 5b), film-like, curved or bent.

The thin injection molded article of the invention may be used as a case housing for an ignition coil bobbin, a cellular phone or the like, but there is no limitation to these uses.

Embodiments of thin injection molded articles of the invention will now be explained with reference to Examples 1-6 and Comparative Examples 1-9

### EXAMPLES 1-7

### Comparative Examples 1-8

First, composite resin materials having the composition listed in Table 1 were prepared. The polymers were modified PPO, PBT (polybutylene terephthalate), PPS (polyphenylene sulfide) and NY66 (nylon 66).

TABLE 1

| | Ex. 1 | Ex. 2 | Ex. 3 | Ex. 4 | Ex. 5 | Ex. 6 | Ex. 7 |
|---|---|---|---|---|---|---|---|
| Modified PPO | 100 | 100 | 100 | 100 | 100 | 100 | |
| PBT | | | | | | | |
| PPS | | | | | | | |
| NY66 | | | | | | | |
| PPE (parts) | | | | | | | 60 |
| HIPS (parts) | | | | | | | 40 |
| Organic clay (*) | 1(1) | 3(1) | 5(1) | 7(1) | 3(2) | 5(2) | 7 |
| Clay (parts) | | | | | | | 0 |
| Glass Fiber | | | | | | | |
| Spiral Flow Length (mm) | 55.4 | 54.5 | 53.3 | 52.7 | 54.7 | 53.8 | |
| Max Flow Length/Average | 94 | 88 | 81 | 78 | 93 | 88 | |
| Thickness (L/t) | | | | | | | |
| Tensile Modulus (GPa) | 2.59 | 2.93 | 3.24 | 3.62 | 3.33 | 3.35 | |
| Dielectric Breakdown | | 21.9 | 22.7 | | | | 45.5 |
| Strength (kV/mm) | | | | | | | |

(*) Number of Organic Agent Types

Composite resin materials comprising modified PPO and organic clay were used for Examples 1-7. A resin material composed only of modified PPO was used for Comparative Example 1 as shown in Table 2.

TABLE 2

| | Comp. | Comp. | Comp. | Comp. | Comp. | Comp. | Comp. | Comp. |
|---|---|---|---|---|---|---|---|---|
| | Ex. 1 | Ex. 2 | Ex. 3 | Ex. 4 | Ex. 5 | Ex. 6 | Ex. 7 | Ex. 8 |
| Modified PPO | 100 | 100 | 100 | | | | | |
| PBT | | | | 100 | | | | |
| PPS | | | | | 100 | | | |
| NY66 | | | | | | 100 | | |
| PPE (parts) | | | | | | | 60 | 60 |
| HIPS (parts) | | | | | | | 40 | 40 |
| Organic clay (*) | | | | | | | 0 | 0 |
| Clay (parts) | | | | | | | 0 | 5 |
| Glass Fiber | | 10 | 20 | | | | | |
| Spiral Flow Length (mm) | 57.2 | 50.6 | 48.3 | | | | | |
| Max Flow Length/Average | 105 | 64 | 50 | | | | | |
| Thickness (L/t) | | | | | | | | |
| Tensile Modulus (GPa) | 2.4 | 3.33 | 4.72 | | | | | |
| Dielectric Breakdown | 21.1 | 21 | 20.3 | 17 | 18 | 16 | 42 | 39.5 |
| Strength (kV/mm) | | | | | | | | |

(*) Number of Organic Agent Types

The organic clay used was montmorillonite rendered organic with stearylammonium. Composite resin materials with glass fiber added instead of organic clay were used for Comparative Examples 2 and 3. Resin materials composed only of PBT, PPS and NY66 were used for Comparative Examples 4, 5 and 6, respectively. For the Comparative Examples 7, 8 and Example 7, polyphenylene ether compositions were used within the composition ranges shown in Table 3 (where “parts” are parts by weight). It should be noted that

TABLE 3

| Ingredients | Amount (parts) |
|---|---|
| (a) Polyphenylene ether | 10 to 90 |
| (b) High impact polystyrene | 90 to 10 |
| (c) Total of (a) and (b): | 100 parts |
| (d) Polybrominated 1,4- | 6 to 18 |
| diphenoxybenzene | per 100 parts of (a) and (b) |
| (e) Antimony oxide | 2 to 6 |
| | per 100 parts of (a) and (b) |

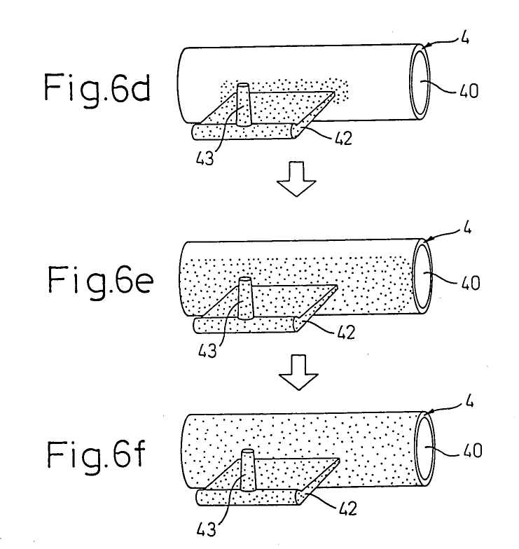

As shown in FIGS. 6a, 6b, 6c, 6d, 6e, and 6f, the (composite) resin materials were injection molded from the gate 41 into the cavity 4 through the sprue 43 and runner 42. The cavity 4 has the same shape as the outer surface of the molded article, in order to mold a cylindrical thin molded article. A core 40 with the same shape as the inner surface of the molded article is fitted inside the cavity 4. The thickness t of the cavity was 0.7 mm.

As shown in FIG. 5b, the resulting thin injection molded article 3 was a cylinder with an average thickness t of 0.7 mm and having a hollow section 30 at the center.

### EXAMPLE 5

As the organic clay there was used montmorillonite that had been rendered organic with stearylammonium and dodecylammonium. The stearylammonium and dodecylammonium were mixed in a ratio of stearylammonium/dodecylammonium =0.8/0.2 (weight ratio) for treatment of the montmorillonite. The other conditions were the same as in Example 2 for preparation of the composite resin material.

### EXAMPLE 6

As the organic clay there was used montmorillonite that had been rendered organic with stearylammonium and hexadecylammonium were mixed in a ratio of stearylammonium/hexadecylammonium =0.5/0.5 (weight ratio) for treatment of the montmorillonite. The other conditions were the same as in Example 3 for preparation of the composite resin material.

For Example 7, 7 parts of an organic clay (corresponding to 5 parts of inorganic clay) was added to PPE (such as YPX100F, manufactured by Mitsubishi Engineering Plastic Co.) and 40 parts of HIPS (such as H238, manufactured by Nippon Polystyrene Co.) were dry blended using melt kneading. The organic clay used was montmorillonite (inorganic clay) rendered organic with stearylammonium. These results are also shown in Table 1.

The spiral flow length, maximum flow length/average thickness (L/t), thin injection molded article tensile modulus and dielectric breakdown strength of the (composite) resin material of the thin injection molded article were measured, and the results are shown in Table 1. The spiral flow length is the value measured by common resin flow property test. The maximum flow length of the thin injection molded article is the distance between the origin A of the gate shown in FIG. 4c and the furthest point B at the edge of the cylinder.

Table 1 shows that Examples 1-7 of the invention had large L/t ratios and high values for tensile modulus and dielectric breakdown strength. The L/t ratios were large in Examples 5 and 6. This demonstrates that, when using clay that has been rendered organic with two types of organic agents, the flow properties of the composite resin are even higher, and even better molding properties and increased thinness can be achieved. Moreover, a high dielectric break down strength is achieved with the use of the organic clay.

In contrast, in Comparative Example 1 that was composed only of modified PPO, the L/t ratio was large but the tensile modulus and dielectric breakdown strength were low. The dielectric breakdown strength for Comparative Examples 4-6 that were composed of polymers other than modified PPO were even lower than Comparative Example 1 that was composed only of modified PPO.

Also, since the composite resins wherein glass fiber was added to the modified PPO (Comparative Examples 2 and 3) had high glass fiber contents of 10 parts by weight and 20 parts by weight respectively, their L/t ratios were smaller than that of the composite resins wherein organic clay was added to the modified PPO (Examples 1-4).

Examples 2 and 3 also had higher dielectric breakdown strengths than Comparative Examples 1, 2 and 3, since the dielectric breakdown strengths were enhanced due to the clay.

### Comparative Example 7

Sixty parts of PPE (such as YPX1OOF, manufactured by Mitsubishi Engineering Plastic Co.) and 40 parts of HIPS (such as H238, manufactured by Nippon Polystyrene Co.) were dry blended. The blend was melt kneaded on a twin screw extruder at about 280 to about 300° C. and extruded into a strand. The extruded strand was pelletized to obtain a PPE/HIPS composition. The resulting composition was injection molded into a plate-like test piece of a size of about 1 mm×about 100 mm×about 150 mm and the test piece was subjected to a dielectric, as described herein, breakdown test using a dielectric breakdown test machine HAT-300-100RHO manufactured by Hitachi Technoservice Co. at 150° C. in silicone oil while raising the voltage at rate of 1 kV/min. The voltage at a current of 5 mA was determined as the dielectric breakdown strength. The result was indicated as an average value of 3 tests and is shown in Table 2.

In Comparative Example 8, the procedure described in Comparative Example 7 was repeated except that 5 parts of clay (montmorillonite: inorganic clay) was added to the blend during the melt kneading. These results are illustrated in Table 2.

It should be noted that the Comparative Example 7 and Comparative Example 8 show dielectric strength of 42 kV/mm and 39.5 kV/mm, respectively, while Example 7 shows an improved dielectric breakdown strength value of 45.5 kV/mm. Thus, it is proved that the addition of inorganic clay results in the decrease of the dielectric breakdown strength as compared with the use of the resin only.

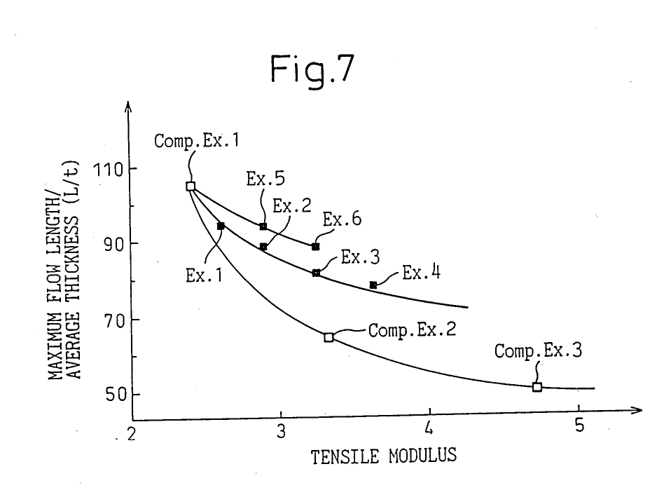

FIG. 7 shows the relationship between tensile modulus and maximum flow lengths for Examples 1-6 and Comparative Examples 1-3. As seen here, the composite materials of modified PPO and organic clay (Examples 1-4) were able to provide higher rigidity for the molded articles with the same maximum flow length, compared to the composite materials of modified PPO and glass fiber.

The experimental results for Examples 5 and 6 also demonstrated that the maximum flow length can be increased by using clay rendered organic with two types of organic agents.

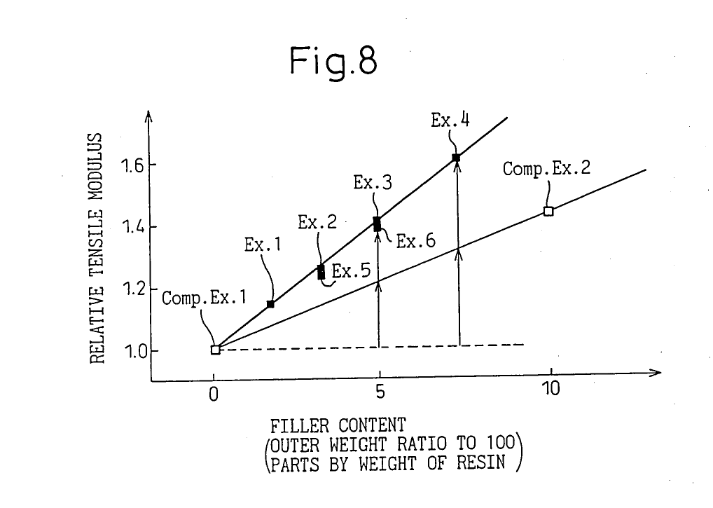

FIG. 8 shows the relationship between the content of the filler (organic clay or glass fiber) in Examples 1-6 and Comparative Examples 1 and 2, and the tensile modulus of the molded product. In FIG. 8, the horizontal axis represents the filler content with respect to 100 parts by weight of polymer, and the vertical axis represents the relative tensile modulus with the tensile modulus of Comparative Example 1 defined as 1.

According to this graph, the rigidity of the composite material comprising modified PPO and organic clay reflected twice the reinforcing effect with the same filler content, compared to the composite resin material comprising modified PPO and glass fiber.

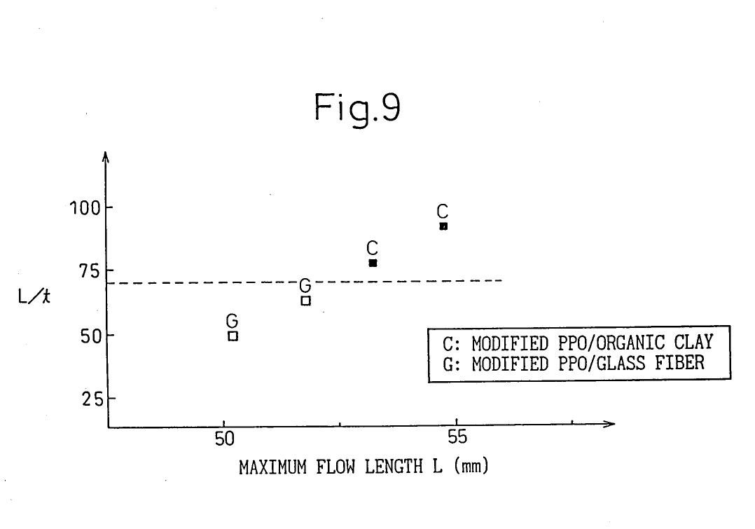

As shown in FIG. 9, measurement of the L/t ratio satisfying the rigidity required for manufactured products (3-5 GPa) indicated that the composite resin materials comprising organic clay and modified PPO had larger L/t ratios than the composite resin materials comprising glass fiber and modified PPO. Thus, by using a composite resin material having organic clay dispersed in modified PPO, it is possible to produce thin, lightweight injection molded articles with excellent rigidity.

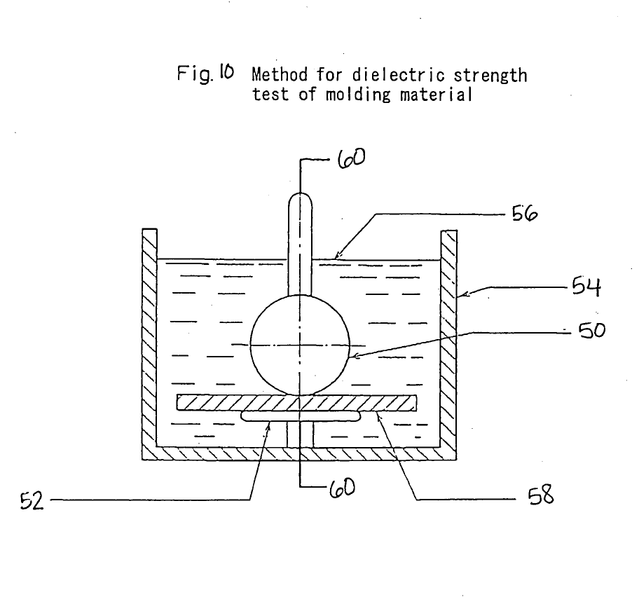

Referring now to FIG. 10, to test the dielectric strength of the thin injection molded article, electrodes 20 mm in diameter are used. The electrodes should generally include a well-polished brass spherical electrode 50 and 25 mm-diameter brass disk-shaped electrode 52 with a 2.5 mm-radius, rounded section at the periphery. The surfaces of both electrodes should be smooth. An appropriate oil tank 54 containing insulating oil 56 and a high-voltage breakdown apparatus (not shown) are also required. The high-voltage breakdown apparatus should be of the type that has a peak factor of between 1.34-1.48, and a maximum voltage of 25 kV or greater which allows the application of voltage at commercial frequency of 50 Hz or 60 Hz between electrodes. Alternatively, a testing transformer with a rating of at least 2 kVA may be used for a voltage of below 50 kV, and of at least 5 kVA for a voltage of 50 kV or greater. The voltage is controlled using a variable ratio autotransformer, a resistance voltage divider, an inductance regulator or the like, or by field regulation with an alternating current generator (not shown). A Grade 1.0 alternating current voltmeter (not shown) is further necessary, with the voltmeter connected according to one of the following methods: (a) connection of alternating current voltmeter to secondary end of potential transformer, (b) connection of static voltmeter to secondary end of testing transformer, (c) connection of alternating current voltmeter to tertiary coil in testing transformer, or (d) connection of alternating current voltmeter to primary end of testing transformer. In this case, the transformer ratio should not vary according to the load. Lastly, a thickness gauge (not shown) is needed and may be an external micrometer for example, or any other type of thickness gauge with an equivalent or greater precision, capable of measuring approximately 50 mm inward from the periphery of a test piece 58. The test piece 58 is molded to a diameter of 60-100 mm and a selected thickness, such as about 2±0.15 mm and pretreated at C-90⁺⁴₋₂h/20±2° C./(65±5) % RH.

The test piece 58 is tested by first measuring the center of the test piece 58 to 0.01 mm with the thickness gauge. The test piece 58 is then placed in the oil tank 54 containing insulating oil 56, electrodes 50 and 52 are then used to sandwich the test piece 58 at approximately the center as shown in FIG. 10, and lead wires 60 are connected to the electrodes 50, 52 to control the voltage. Both electrodes 50, 52 are held when sandwiching the test piece so that their center lines are in vertical alignment. The voltage is increased as rapidly as possible at a uniform rate from zero to the test voltage, and it is observed whether or not the test piece 58 can withstand the test voltage for one minute. The test voltage used in this case is the voltage calculated by multiplying the thickness t in millimeters of the test piece 58 (mm) by the specific voltage gradient (kV/mm). The temperature of the insulating oil is approximately 150° C.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for forming a thin injection molded article comprising the steps of:
preparing a liquid composite resin material comprising 100 parts by weight of a polymer and between 1 and 15 parts by weight of an organic clay dispersed in the polymer, wherein
the polymer comprises polyphenylene oxide and a butadiene-styrene copolymer, and
the organic clay comprises at least one member selected from the group of inorganic clays consisting of montmorillonite, saponite, hectorite, beidellite, stevensite, nontronite, vermiculite, halloysite, mica, fluorinated mica, kaolinite and pyroferrite, the at least one member having been rendered organic through treatment with at least one organic agent, wherein the treatment also separates layers of the organic clay to form mono layer particles; and
injecting a flow of the composite resin material into a mold, the composite resin material being injected into the mold through a mold gate and flowing within the mold in a manner characterized by a maximum flow length L to fill the mold substantially completely and form the thin injection molded article having an average thickness t, the maximum flow length L and the average thickness t of the thin injection molded article satisfying the inequality: L/t≧70;
treating the thin injected molded article to produce a substantially solid composite resin material within the mold, the solid composite resin material having a tensile modulus of at least 2.59 GPa and a dielectric breakdown strength of at least greater than 21.1 kV/mm; and
removing the thin injected molded article from the mold.

2. A method for forming a thin injection molded article according to claim 1, wherein the at least one organic agent is selected from a group of organic onium ions consisting of hexylammonium, octylammonium, 2-ethylhexylammonium, decylammonium, dodecylammonium, laurylammonium, hexadecylammonium, octadecylammonium, dioctyl-dimethylammonium, trioctylammonium, dioctadecyldimethylammonium, trioctadecylammonium, tetraethylphosphonium, triethylbenzylphosphonium, tetra-n-butylphosphonium, tri-n-butylhexadecylphosphonium and tri-n-butylbenzylphosphonium ions.

3. A method for forming a thin injection molded article comprising the steps of:
preparing a liquid composite resin material comprising 100 parts by weight of a polymer and between 1 and 15 parts by weight organic clay dispersed in the polymer, wherein
the polymer comprises polyphenylene oxide and a butadiene-styrene copolymer, and
the organic clay comprises at least one member selected from the group of inorganic clays consisting of montmorillonite, saponite, hectorite, beidellite, stevensite, nontronite, vermiculite, halloysite, mica, fluorinated mica, kaolinite and pyroferrite, the at least one member having been rendered organic through treatment with at least two organic agents; and
injecting a flow of the composite resin material into a mold, the composite resin material being injected into the mold through a mold gate and flowing within the mold in a manner characterized by a maximum flow length L to fill the mold substantially completely and form the thin injection molded article having an average thickness t, the maximum flow length L and the average thickness t of the thin injection molded article satisfying the inequality: L/t≧70;
treating the thin injected molded article to produce a substantially solid composite resin material within the mold, the solid composite resin material having a tensile modulus of at least 2.59 GPa and a dielectric breakdown strength of at least greater than 21.1 kV/mm; and
removing the thin injected molded article from the mold.

4. A method for forming a thin injection molded article according to claim 3, wherein the organic agent is selected from a group of organic onium ions consisting of hexylammonium, octylammonium, 2-ethylhexylammonium, decylammonium, dodecylammonium, laurylammonium, hexadecylammonium, octadecylammonium, dioctyldimethylammonium, trioctylammonium, dioctadecyldimethylammonium, trioctadecylammonium, tetraethylphosphonium, triethylbenzylphosphonium, tetra-n-butylphosphonium, tri-n-butylhexadecylphosphonium and tri-n-butylbenzylphosphonium ions.

5. A method for forming a thin injection molded article according to claim 5, wherein the dielectric breakdown strength is not more than about 22.7 kV/mm.

6. A method for forming a thin injection molded article according to claim 7, wherein the dielectric breakdown strength is not more than about 22.7 kV/mm.
